(19) United States
(12) Patent Application Publication
(10) Pub. No.: US 2008/0210702 A1
(43) Pub. Date: Sep. 4, 2008

(54) Integrated Product Inventory and Dispensing System, and Personal Dental Care Unit Having Disposable Containers with State-Sensitive Elements

(76) Inventors: Alexander Lochinger, Campbell, CA (US); Ivy Y. Mei, San Jose, CA (US); Wonnie Bae, El Sobrante, CA (US); Nancy Tsai, Campbell, CA (US); Robert F. Dennis, Sunnyvale, CA (US)

Correspondence Address: ROBERT F. DENNIS, ORAYA THERAPEUTICS, INC., 8000 JARVIS AVE, BLDG.5, NEWARK, CA, 94560, US

(21) Appl. No.: 10/546,934

(22) PCT Filed: Jun. 21, 2005
(86) PCT No.: PCT/US05/21821

§ 371 Date: Apr. 10, 2008

Related U.S. Application Data
(60) Provisional application No. 60/581,670, filed on Jun. 21, 2004.

(30) Foreign Application Priority Data
Jun. 3, 2005 (CN) 2005 10073380.2

(51) Int. Cl. G07F 11/00

(52) U.S. Cl. 221/7; 235/385; 206/459.5

(57) ABSTRACT

The various aspects of the invention include embodiments of an integrated consumer or household product dispensing system which include one or more releasable product containers which are preferably disposable, and which include state-sensitive elements in communication with a processor, and which provide for the enhancement of the convenience, safety and efficiency of product use and re-supply. Certain embodiments of the dispensing system can automatically and/or semi-automatically manage a users inventory of one or more products and determine when re-supply is needed. Further embodiments of the dispensing system can automatically and/or semi-automatically place re-supply transactions with E-commerce suppliers and/or carry out related transactions with shippers and financial institutions, so as to provide for convenient product container re-supply. Further exemplary embodiments including a personal dental care dispenser system are described.

### FIELD

The invention relates to product inventory and dispensing systems, and more particularly to electronic household and personal product inventory and dispensing systems

### BACKGROUND

Various household and consumer products, such as cleaners, chemicals, cosmetics, foods, beverages, dental supplies, and the like, require safe and convenient storage in a modern household. The large number of different products desired and used in a typical consumer household contributes to storage space limitation, clutter and disorganization, as well as potential health and safety hazards.

Examples include many different dental care and personal hygiene products consumers typically store in cabinets or on counters of the bathroom, creating clutter, inconvenient access and unhygienic storage for such items as toothbrushes and the like. Indeed, microorganisms carried on toothbrushes are known to be a significant source of infection and re-infection.

In another example, many different cleaning, polishing and disinfecting products and the like are typically store by consumers in a cabinet under the kitchen sink. In addition to creating clutter, such storage tends to include many products which are toxic, corrosive or which are hazardous to young children.

What is needed is an integrated system which provides logical, compact, hygienic and aesthetically pleasing storage together with convenient dispensing, so as to save space and reduce clutter. What is also needed is an integrated system which stores such substances as are potentially harmful in a manner that is safe for small children.

What is additionally desirable is a type of product container to be used with such systems which has the convenience of being disposable and/or which provides synergistic functional enhancement of the integrated system beyond merely supplying the particular substance or substances contained therein.

What is additionally desirable is a consumer product dispensing system which can automatically and/or semi-automatically manage a users inventory of one or more products and determine when re-supply is needed.

What is additionally desirable is a consumer product dispensing system which can automatically and/or semi-automatically place re-supply transactions with E-commerce suppliers and/or carry out related transactions with shippers and financial institutions, so as to provide for convenient product container re-supply.

It should be understood that these needs also are relevant to broader industrial or commercial applications, such as public restrooms, athletic clubs, hospitals, hotel rooms and the like.

### SUMMARY

A first exemplary embodiment according to certain aspects of the invention includes an integrated dispensing console system comprising a base; one or more docking receptacles for product containers, and one or more containers configured to mate with a corresponding receptacle. One or more of the containers is preferably disposable. Alternatively, one or more of the containers may be refillable or refurbishable.

A second exemplary embodiment according to certain aspects of the invention includes an integrated dispensing console system comprising a base; at least two docking receptacles for product containers, and at least two containers configured to mate with a corresponding receptacle. Each of the at least two containers is configured to supply a product suitable for optimal use in conjunction and/or in sequence with the contents of the other of the at least two containers.

A third exemplary embodiment according to certain aspects of the invention includes an integrated dispensing console system comprising a base; at least two docking receptacles for product containers, and at least two containers configured to mate with a corresponding receptacle. A first one of the at least two containers includes a first receptacle-specific mating portion configured to engage a first one of the at least two docking receptacles, and a second one of the at least two containers includes a second receptacle-specific mating portion configured to engage a second one of the at least two docking receptacles, the first and second first receptacle-specific mating portions being substantially distinct in conformation so that the first container is substantially prevented from docking in the second receptacle and/or the second container is substantially prevented from docking in the first receptacle, the contents of the first and second containers being substantially different.

A fourth exemplary embodiment according to certain aspects of the invention includes an integrated dispensing console system comprising a base; one or more docking receptacles for product containers mounted to the base, and one or more product containers configured to mate with a corresponding one of the receptacles. One or more of the containers preferably includes at least one state-sensitive element. Either or both of the containers and any corresponding state-sensitive element are preferably disposable.

The term “state-sensitive element” includes structures or devices configured (a) to detect, and/or measure, and/or to facilitate the detection and/or measurement of, one or more quantities or conditions related to properties of the container contents and/or the container; (b) to store, receive, and/or transmit information related to one or more properties, history, and/or use of the container contents and/or the container; (c) to modify, to condition and/or to regulate one or more properties of the container contents and/or the container; (d) to provide an energy source and/or energy storage; (e) to control, to energize and/or to activate the dispensing of container contents; or (f) to carry out a combination of two of more of the foregoing.

In certain examples the at least one state sensitive element is configured to perform a user-communication function, such as to display a container contents fill-level, contents temperature, and/or contents pressure, and the like.

A fifth exemplary embodiment according to certain aspects of the invention includes an integrated dispensing console system comprising a base; one or more docking receptacles for product containers mounted to the base, and one or more product containers configured to mate with a corresponding one of the receptacles.

One or more of the containers preferably includes at least one state-sensitive element. Either or both of the containers and any corresponding state-sensitive element are preferably disposable. Furthermore, the console includes a processing element in communication with an interface element disposed adjacent to the docking receptacle, the interface element configured to engage and/or acquire a corresponding transfer element disposed on or in the container in communication with the state-sensitive element, so as to enable at least one signal to be transmitted between the container state-sensitive element and the console processing element when the container is mated with the docking receptacle and/or following such mating. The interface element may be configured to engage the transfer element so as to provide an electrical current path between the container and the console. Alternatively, the interface element may be configure to engage the transfer element so as to permit wireless, optical, RF, magnetic, mechanical, acoustical and/or another signal transmission modality.

In certain examples, the state-sensitive element may include one or more of the following: a contents fill-level sensor, a temperature sensing element, a heating element, a cooling element, a power-storage element, a battery-charge detector, a contents quality control log memory, an environmental conditions log memory, a product identification memory, a pH sensor, a storage-life indicator, a quality preservation sensor, a use-cycle memory, a pressure-detector, a product-to-dispenser compatibility indicator, a contents specification memory, a material safety data memory, a poison control data memory, an instructions-for-use memory, a calibration memory, and the like or combinations thereof.

The signal(s) transmitted between the container state-sensitive element and the console processing element may include a power signal to and/or from the container, a data signal to and/or from the container, a detector signal to and/or from the container, and the like, or combinations thereof.

In certain examples of the foregoing fifth embodiment, the state-sensing element, interface and transmission element may together comprise a pathway, orifice and/or window adjacent to a transmission point for a signal from the console, such that the signal may pass from the transmission point on to and/or into the container, the signal thereafter penetrating through, being reflecting from, being diffracted by, being diffused by, and/or being refracted by (or by a combination of these events), the container and/or its contents so as to be received at a corresponding reception point on or in the console, the signal being modified by the penetration, reflection, diffraction, diffusion and/or refracted by (or a combination of these events), so as to detect useful information from the container and/or its contents, the information being transmitted to the processing element.

For example, an optical signal may be transmitted from the console so as to reflect off a pattern printed or inscribed on the container, the pattern or sequence of reflection being received as a modulated optical signal by an optical detector at the reception, the detector transmitting useful information from the modulated optical signal to the processing element.

In another example, an ultrasound signal may be transmitted from the console to penetrate a wall of the container, reflect off the contents of the container, and be received by a detector adjacent to the console, the detector providing a signal transmitting useful information (such as quantitative or qualitative data of the contents to the processing element.

A sixth exemplary embodiment according to certain aspects of the invention includes the elements as set forth above relative to the fifth embodiment, and further the processing element is configured to use the one or more signals to at least (a) control a dispensing function of the console; and/or (b) to control a user-interface device disposed adjacent to the console; and/or (c) to control an output device disposed adjacent to the console; and/or (d) to regulate or change the temperature, pressure or energy charge-level of the contents of the container.

A seventh exemplary embodiment according to certain aspects of the invention includes an integrated dispensing console system comprising a base; one or more docking receptacles for product containers mounted to the base, and one or more product containers configured to mate with a corresponding one of the receptacles. The console further includes a security lock device arranged to prevent access by an un-authorized potential user from one of (a) dispensing the product contents of one or more of the containers; and/or (b) disengaging one or more of the containers from its respective docking receptacle, while permitting an authorized user access as in (a) and/or (b) above.

In certain examples of this seventh embodiment, the security lock device may be configured and/or marked so as to provide for substantially convenient and self-explanatory access by a typical adult as in (a) and/or (b) above, while being configured to substantially resist access by a typical child younger than a pre-determined age as in (a) and/or (b) above.

In certain examples of this seventh embodiment, the dispensing console system includes the elements of the sixth embodiment as described above; the state-sensitive element produces the at least one signal based on a hazard potential of the contents of the container; the security lock device has a first mode in which access as in (a) and/or (b) above is not restricted and a second mode in which an access by an un-authorized potential user as in (a) and/or (b) above is substantially resisted; and the processing element is configured to use the at least one signal to control the security lock device so that the mode is switchable between the first and second modes above based on the hazard potential signal.

An eighth exemplary embodiment according to certain aspects of the invention includes an integrated dispensing console system comprising a base; one or more docking receptacles for product containers mounted to the base, and one or more product containers configured to mate with a corresponding one of the receptacles. The console includes a treatment unit, the treatment unit being in communication with at least a first one of the containers via its respective docking receptacle so as to provide controlled movement of the contents of the first container to the treatment unit. The treatment unit is configured to receive an implement, device and/or tool to be treated, and to utilize the contents of the first container to perform at least part of a treatment of the implement, device and/or tool.

In certain examples of this eighth embodiment, the treatment unit includes a toothbrush sanitizer, and/or a toothbrush hygienic storage station. The term toothbrush sanitizer as used herein includes a sterilizer, a cleaner, a disinfector, and the like, or combination thereof, any of which may use one or more of number of different modalities for cleaning one or more of a toothbrush, inter-dental pick or other dental care implement and/or eliminating and/or controlling microorganisms. In certain examples of this embodiment, the first container provides a sanitizing fluid to the sanitizer, the sanitizer arranged to automatically apply one or more doses of the sanitizing fluid to a toothbrush or other implement during and/or after placement of the toothbrush or other implement into the treatment unit by a user, for example, by employment of a fluid spray nozzle. Alternatively, the console may include a user-operated control device permitting the user to selectively apply a dosage of sanitizing fluid.

An ninth exemplary embodiment according to certain aspects of the invention includes an integrated dispensing console system comprising a base; a plurality of docking receptacles for product containers mounted to the base, and a plurality of product containers configured to mate with at least one of the receptacles. One or more of the container or the console includes at least one detector configured to determine fill-level and/or product quantity and/or charge-level and/or useful life of the contents of at least one container.

In certain examples the plurality of containers may include a plurality of substantially identical individually-releasable containers, at least one of the receptacles including a magazine for housing the individually-releasable containers, the magazine arranged for release of at least one of individually-releasable containers upon user input, and the detector produces a signal indicative of the remaining number of single-use containers housed in the magazine.

In certain examples, the console includes a processor unit in communication with the one or more detectors, the processor having an output configured to be connected with the internet. The internet connection output may include and/or be connectable to: a wireless transceiver; and/or a modem; and/or a local area network connection device; or combination thereof.

For example, the console may have a wireless transceiver configured to communicate with a conventional household wireless device having an internet connection, so that the processor unit may send and/or receive data signals via the internet, either automatically, upon user command input, and/or upon remote command signal.

In one alternative, the console may have a wired or wireless device configured to communicate with a conventional personal computer, either automatically or upon upload and/or download command. The personal computer may in turn have a conventional internet connection device, so that the personal computer may send and receive data signals via the internet based, so as to provide for internet communication related to data transmitted to and/or from the console and the personal computer.

In another alternative, the console may incorporate and/or be connected to a cellular phone unit, the cellular phone unit configured to transmit data signals to and/or from the console processing unit and a receiver, the receiver optionally being connected to the internet so as to enable the console to communicate via the internet.

In certain examples the processor unit is configured to communicate via the internet, either automatically, upon user command input, and/or upon remote command signal, so as to electronically place an order to an on-line supplier for at least one replacement container for one or more product containers. For example, the processor may electronically place an order when the processor determines from the one or more detectors that the fill-level and/or product quantity and/or charge-level and/or useful life and/or remaining number of individually-releasable containers is less than a pre-determined quantity.

Optionally, the processing unit may include a clock and detector data memory, the processing unit being configured to determine a predicted product exhaustion time based on actual product use history of at least one of the products of the containers based on signals from the at least one detector, and the processor may be configured to electronically place an order to an on-line supplier for at least one replacement container at a predetermined time prior to the predicted exhaustion time.

Optionally, the processing unit may include an inventory management system configured to manage electronic orders to an on-line supplier for a plurality of products based on predicted exhaustion times for the products, so as to minimize shipping charges and/or handling charges and/or user inconvenience due to product exhaustion. The inventory management system may optionally include user-programmable elements, software elements, and/or hardware elements. The inventory management system may optionally include elements housed or stored on at least one separate computer operatively linked to the processing unit of the console, the at least one separate computer being local and/or remotely situated.

It should be understood that any of the above described embodiments may be produced and marketed in various forms, combinations and sub-combinations, kits and the like. In particular, one embodiment according to certain aspects of the invention includes a disposable container with or without contents, such as described in one or more of the examples above, the container configured to mate with a docking receptacle of an integrated dispensing console system according to other aspects of the invention. Similarly, such consoles may be provided to a user separately from its respective container or containers, and kits may be provided to a user including more than one kind of product substance and container.

An first exemplary business method according to certain aspects of the invention includes the steps of:

a. providing for sale and/or distribution to one or more consumers, one or more integrated dispensing console systems, such as are described above according to certain aspects of the invention, wherein optionally each such console system may be sold in the range of a nominal profit to a loss;

b. optionally providing an initial supply of one or more product containers in conjunction with the sale and/or distribution of the one or more integrated dispensing console systems, the container configured to operatively mate and engage a docking receptacle of the console, wherein the container may be disposable, and wherein optionally the product substance of the initial supply including its container may be sold in the range of a nominal profit to a loss;

c. thereafter, to at least consumers who buy and/or receive a console described in step (a), providing for sale and/or distribution one or more product substances in one or more replacement containers such as are described above according to other aspects of the invention, the container configured to operatively mate and engage a docking receptacle of the console, wherein the container may be disposable, and wherein the product substance including its container is sold at a substantial profit;

d. optionally, one or more of the containers may include a state sensitive element configured to communicate with a processing element of the console upon docking, the processing element having an output providing at least one functionality to the consumer as described above according to other aspects of the invention, the at least one functionality enhancing the market appeal of the product substance and/or its container, so as to encourage repeat sales of replacement containers at a substantial profit.

An second exemplary business method according to certain aspects of the invention includes the steps of:

a. providing for sale and/or distribution to one or more consumers, one or more integrated dispensing console systems as described with respect to the ninth embodiment above, and optionally wherein each such console system may be sold in the range of a nominal profit to a loss;

b. optionally providing an initial supply of one or more product containers in conjunction with the sale and/or distribution of the one or more integrated dispensing console systems, the container configured to operatively mate and engage a docking receptacle of the console, wherein the container may be disposable, and wherein the product substance of the including its container initial supply may be sold in the range of a nominal profit to a loss;

c. thereafter, to at least consumers who buy and/or receive a console described in step (a), providing for sale and/or distribution one or more product substances in at least one replacement container having replacement product, such as are described above according to other aspects of the invention, the container configured to operatively mate and engage a docking receptacle of the console, wherein the sale and/or distribution of the replacement container is provided by an on-line supply website and/or on-line order center, the on-line supply website and/or on-line order center being configured to accept and process orders transmitted via the internet from a processing unit of the at least one console, and wherein the replacement container may be disposable, and wherein the replacement product substance including its replacement container is sold at a substantial profit;

It should be understood that the above described embodiments and examples are not exhaustive, and other embodiments within the scope and spirit of the invention are possible, including combinations of the different aspects of the described embodiments.

### DRAWINGS

FIG. 1 shows perspective front view of an exemplary embodiment according to certain aspects of the invention configured as a dental care product system.

FIG. 2 shows a view of the embodiment of FIG. 1 with a console cover removed to show aspects of the internal structure.

FIG. 3 shows perspective side view of an exemplary embodiment of a product container according to certain aspects of the invention configured to mate and engage with the console shown in FIGS. 1 and 2.

FIG. 4 shows a top cross-sectional view of a portion of the embodiment of FIG. 1 showing the docking receptacle mated to the container shown in FIG. 3, illustrating that a portion of the front of the container is exposed to present a contents level gage to the view of the user.

FIG. 5 shows perspective side view of an alternative exemplary embodiment of a product container according to certain aspects of the invention configured to mate with the console similar in general to that shown in FIGS. 1 and 2, but wherein the front of the container is generally contained within the console, and showing a state-sensitive element comprising a disposable integral contents fill-level sensor and transfer element for transmitting a fill-level signal to the console.

FIG. 6 shows a top cross-sectional view of a portion of a console similar in general to that shown in FIGS. 1 and 2, showing the docking receptacle mated to the container shown in FIG. 5, illustrating that a portion of the front of the container is generally contained within the console.

FIGS. 7A-7C show a schematic views of three different exemplary displays which may be included as a user communication output device disposed adjacent to the console and container shown in FIGS. 5 and 6, in which FIG. 7A illustrates a multicolor LED bar display; FIG. 7B illustrates a tube-gage display; and FIG. 7C illustrates a LCD and/or other flat-panel type display having multiple data display portions with both text and graphic output types.

FIGS. 8-10 shows perspective front views of an exemplary embodiment according to certain aspects of the invention configured as a consumer product dispensing system; in which FIG. 8 show the dispensing system with a front access door in a closed position revealing an exemplary LCD display; FIG. 9 show the dispensing system of FIG. 8 with the door opened to reveal a plurality of product containers; and FIG. 10 show the dispensing system of FIGS. 8 and 9, further showing the projection of the containers into the corresponding docking receptacles.

FIG. 11 is a diagram showing an exemplary embodiment according to certain aspects of the invention configured as a consumer product dispensing system having an internet connection for automated replacement container ordering and inventory management.

### DETAILED DESCRIPTION

### General Remarks

The following detailed description illustrates the invention by way of example, not by way of limitation of the principles of the invention. This description will clearly enable one skilled in the art to make and use the invention, and describes several embodiments, adaptations, variations, alternatives and uses of the invention, including what is presently believed to be the best mode of carrying out the invention.

In this regard, the invention is illustrated in the several figures, and is of sufficient complexity that the many parts, interrelationships, and sub-combinations thereof simply cannot be clearly or meaningfully illustrated in a single patent-type drawing. Accordingly, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

A “processing element”, processing unit” and “processor” or “computer” as most broadly used herein may include a number of components such as hardware components, firmware components memory components, power supply components, heat dissipation components, input/output components, software components, and the like, and may include any programmable processor suitably programmed to carry out the tasks required by any of the various aspects of the present invention, or hardware and/or software equivalents. Thus, a suitable computer may generally be embodied in a device which may be thought of as having a primary function other than computations, for example a telephone (including a wired or wireless telephone such as a cellular phone or a telephone using satellite communications) or other appliance (for example, a “smart” television which includes a processor and a suitable two-way communication device). It is particularly convenient to store data sets in the same file to allow a computer to readily access the data. Any computer readable storage medium or device referenced in this application, may be any medium capable of storing data in a form which can be read by a computer, such as a solid state random access memory (RAM), magnetic or optical disk or tape, or any other suitable medium which is preferably erasable. A “file” includes the concept of multiple data elements arranged such that they can be accessed as a group by the computer's operating system using a common identifier (particularly, a “file name”).

The term “Internet” as generally used herein refers to a well-known computer network whereby multiple computers can communicate with one another to exchange data (including computer programs). The communication at different nodes on the network, may be by wire, optical, radio, satellite or any suitable signal transmission medium or combinations of these. The Internet is a loose, and changing, confederation of computers and private or public computer networks, which have agreed to connect with one another. The term “World Wide Web” or “WWW” as used herein refers to a sub-set of the Internet, and allows users to navigate between servers by selecting a highlighted word, symbol, picture or other designation (which are known as “hyperlinks”). To accomplish this, generally a user may load on their computer a suitable “web browser” program, such as commercially available Netscape Navigator or Microsoft Internet Explorer. An “Intranet” operates essentially the same as the Internet, except access to the network defined by an Intranet is usually controlled (for example, to only a company's employees). Often an Intranet may be connected to become part of the Internet, but usually such access is through a “firewall” which essentially is hardware and/or software designed to limit access and/or use of the Intranet.

All publications and patent applications cited in this specification are herein incorporated by reference as if each individual publication or patent application were specifically and individually indicated to be incorporated by reference.

### Description of Exemplary Embodiments

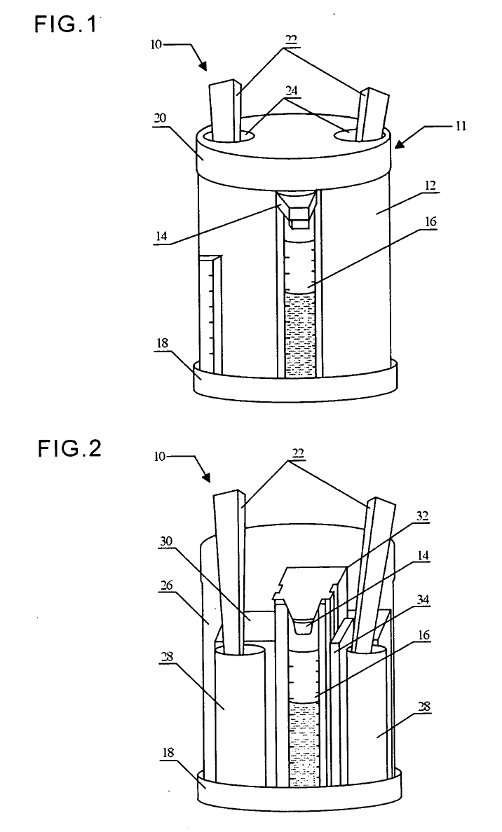

FIGS. 1 and 2 shows perspective front view of an exemplary embodiment according to certain aspects of the invention configured as a dental care product system 10, FIG. 2 showing the system with a console cover 11 removed to show aspects of the internal structure. Dispensing spigot 14 is shown on the console front above a contents fill-level display 16. The console includes a base 18, the console cover including a side cover 12 and a top cover 20. An exemplary pair of handles of toothbrushs 22 are shown projecting from a corresponding pair of toothbrush sanitizer openings 24 in top cover 20.

FIG. 2 shows the embodiment of FIG. 1 with the cover (11) removed, revealing console frame 26 adjacent which are mounted a pair of toothbrush sanitizer housings 28 receiving the head portions of the pair of toothbrushes 22. Adjacent sanitizer housings 28 is a sanitizer fluid reservoir or container 30, which may be refillable, removable and/or disposable. Toothpaste container 32 is shown engaged with docking receptacle 34 mounted either or both of base 18 and/or frame 26. The arranged between sanitizer toothpaste container 32 is arranged between sanitizer housings 28, and includes, in this example, integral contents fill-level display 16 and dispensing spigot 14.

In this example, the sanitizer fluid reservoir container 30 provides a sanitizing fluid to the sanitizer housings 28, the sanitizer arranged to automatically apply one or more doses of the sanitizing fluid to a toothbrush or other implement during and/or after placement of the toothbrush or other implement into the treatment unit by a user, for example, by employment of a fluid spray nozzle (not shown in FIG. 2). Alternatively, the console may include a user-operated control device (not shown in FIG. 2) permitting the user to selectively apply a dosage of sanitizing fluid. The console may contain fluid energizer such as a pump, compressor and/or pressure source to assist in applying the sanitizer fluid to the toothbrush within the sanitizer housing. The base 18 may include a spent fluid reservoir (not shown in FIG. 2) to hold spent sanitizer fluid.

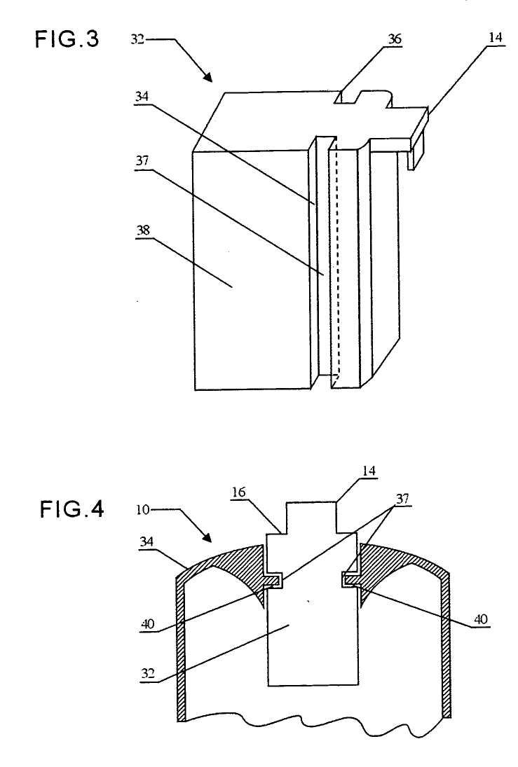

FIG. 3 shows perspective side view of an exemplary embodiment of a product container (shown as a toothpaste container 32) according to certain aspects of the invention configured to mate and engage with the console shown in FIGS. 1 and 2. Container 32 includes integral contents fill-level display 16 and dispensing spigot 14. Container 32 includes mating elements 36 to provide for conveniently releasable engagement with the docking receptacle of the console 10. In this example, the mating elements 36 comprise an opposed pair of vertical engagement slots 37 on each of sides 38 of container 32. It should be understood that the mating elements may optionally have other shapes and may be located on other surfaces than the container sides 28.

FIG. 4 shows a top cross-sectional view of a portion of the console embodiment of FIG. 1 showing the docking receptacle 34 mated to the container 32 shown in FIG. 3, illustrating that a portion of the front of the container is exposed to present a contents level gage 16 to the view of the user. Each of the pair of engagement slots 37 are shown engaged to a corresponding pair of mating protrusions 40 of docking receptacle 34.

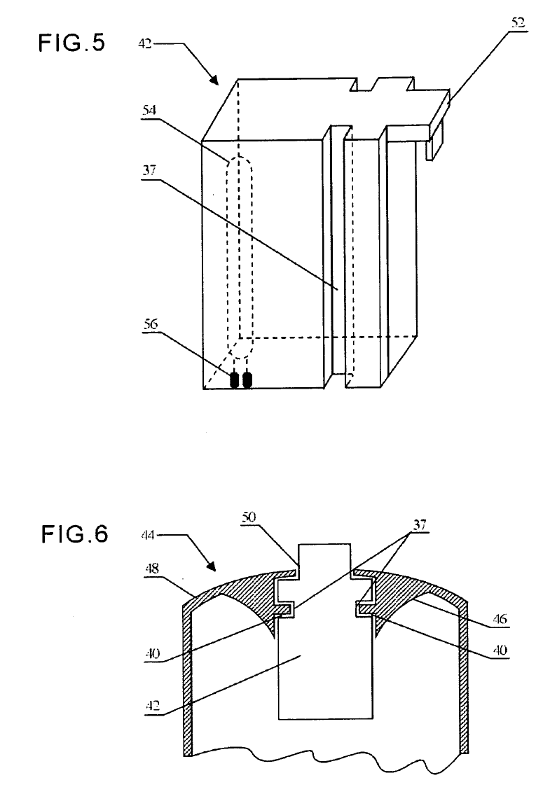

FIGS. 5 and 6 show an alternative exemplary embodiment of a product container 42 according to certain aspects of the invention. The container 42 is configured to mate with a console 44, similar in general to that shown in FIGS. 1 and 2. FIG. 5 shows perspective side view of a the product container 42, and FIG. 6 shows a top cross-sectional view of a portion of a console 44 showing the docking receptacle 46 mated to the container 42 shown in FIG. 5. Note that in this example the front 46 of the container 42 is generally contained within the cover shell 48 of console 42. Note that container 42 includes integral dispensing spigot 52.

Alternatively, the container 42 may be configured to mate with a output port (not shown in FIGS. 5-6) in the docking receptacle, so as to permit container contents (toothpaste in this example) to be transferred to separate dispensing elements (not shown in FIGS. 5-6) mounted to the console 44.

As shown in FIG. 5, the container includes a state-sensitive element 54 in communication with a transfer element 56. One example of a disposable state-sensitive element suitable for inclusion in the container shown in FIG. 5 is an electromagnetic fluid level sensor. An electromagnetic fluid level sensor of this general type is described in U.S. Pat. No. 6,023,970 issued to David H Blaine. In such an example, the transfer element 56 may comprise electrical contacts configured to engage corresponding contacts (not shown in FIGS. 5-6) on docking receptacle 46, so as to permit state-sensitive element 54 transmits at least one signal via transfer element 56 to a processor element in console 44.

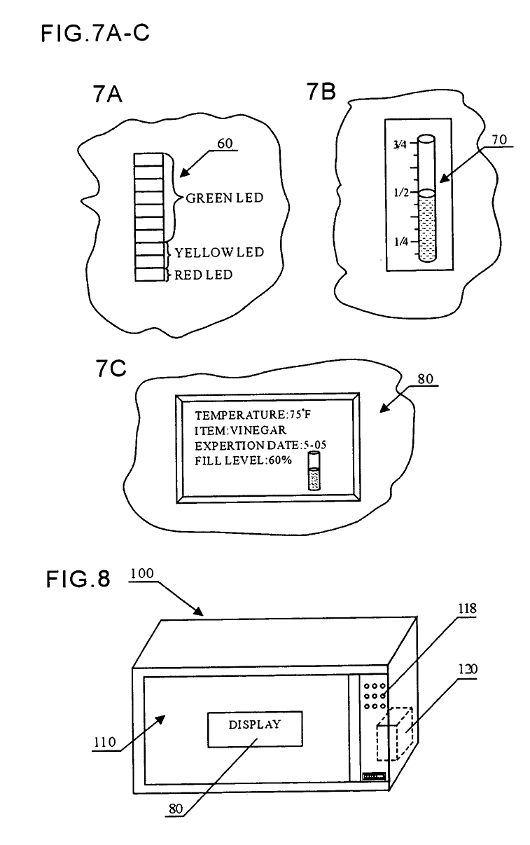

FIGS. 7A-7C show a schematic views of three different exemplary displays which may be included as a user communication output device according the certain aspects of the invention, such as may be included in the consoles 10 and 44 described above, and/or in the dispenser system described below with respect to FIGS. 8-10. FIG. 7A illustrates a multicolor LED bar display 60; FIG. 7B illustrates a tube-gage display 70; and FIG. 7C illustrates a LCD and/or other flat-panel type display 80 having multiple data display portions with both text and graphic output types.

For example, container 32 may include an integral tube-gage display 16 generally similar to display 70 projecting through the cover 12 of console 10. Alternatively a virtual tube-gage comprising graphic elements, such as pixels of a LCD display, may be substituted for a physical tube-gage display. In another example, integral display 16 may comprise a transparent window portion of container 32, whereby the use may directly view the fill level of container 32, assisted by suitable calibration and/or scale markings.

In another example, the state-sensitive element 54 of container 42 may transmit a fill-level signal to the processor element of console 44, the processor in turn determining a corresponding output signal for transmission to multicolor LED bar display 60 ( mounted to console 44, the display 60 (not shown in FIGS. 5-6) showing graphically a fill-level indication to the user.

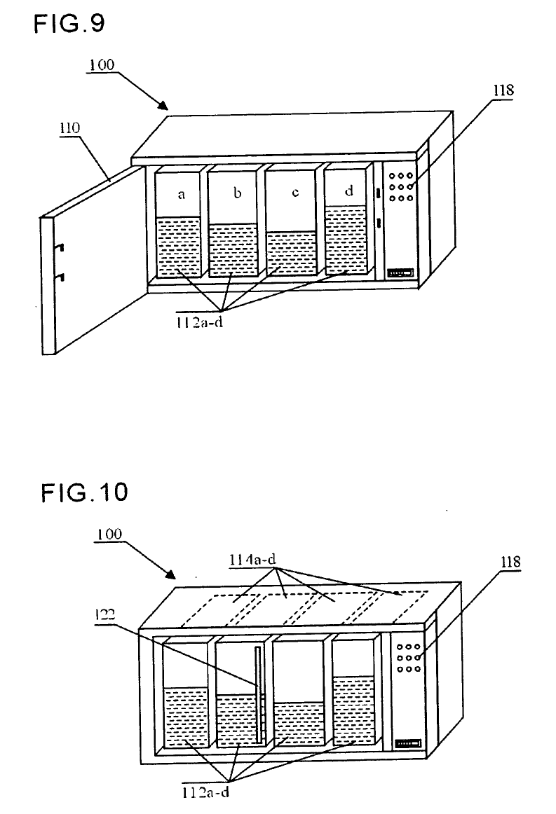

FIGS. 8-10 shows perspective front views of an exemplary embodiment according to certain aspects of the invention configured as a consumer product dispensing system 100; in which FIG. 8 show the dispensing system 100 with a front access door 110 in a closed position revealing one or more display devices, such as exemplary LCD display 80; FIG. 9 show the dispensing system 100 of FIG. 8 with the door 110 opened to reveal one or more (four are shown in this example) product containers 112a-112d; and FIG. 10 show the dispensing system of FIGS. 8 and 9, further showing the projection of the containers 112a-112d into the corresponding docking receptacles 114a-114d. The display 80 is in communication with a processor element 120 mounted within dispensing system 100.

The dispensing system 100 may be sized to permit convenient mounting or placement in convenient household locations, such as beneath a kitchen sink, or within a kitchen cabinet. The housing 116 of dispensing system 100 may include a user-input panel 118 to permit user inputs to processor element 120.

One or more of the containers 112 may include at least one state-sensitive element 122, such as a fill-level detector generally similar to the sensitive element 54 shown in FIG. 5. Similarly, the state-sensitive element 122 may be configured to transmit at least one signal via transfer elements (not shown) of the corresponding docking receptacle 114 to the processor 120. Data from one or more state-sensitive elements may be used by the processor 120 to determine one or more output signals to control display data shown to the user on display 80.

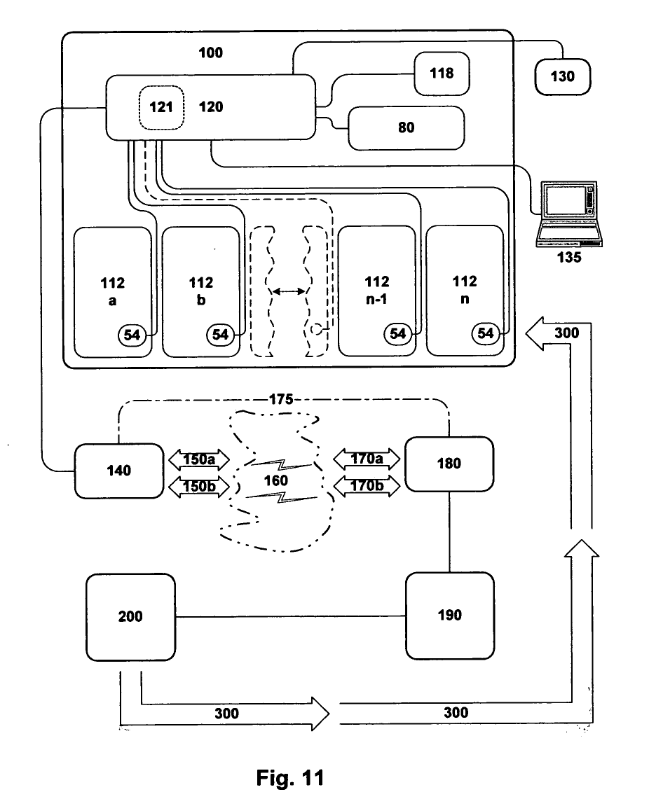

FIG. 7C shows an example of a output data on display 80. As shown, the display 80 may show multiple data items related to a single product container, data items related to different containers, data not specific to a particular container, and/or data input by a user, or a combination of these. In addition to the at least one state-sensitive element 122 included in one or more of the containers 112, additional state-sensitive elements may be located on, within or adjacent to the dispensing system 100 in communication with processor element 120. Likewise, processor element 120 may receive data from and/or transmit data to from external sources, such as is described below with respect to FIG. 11, and externally derived data may be displayed on display 80.

FIG. 11 is a diagram showing an exemplary embodiment according to certain aspects of the invention configured as a consumer product dispensing system 100 having an internet connection 160 for automated replacement container ordering and inventory management. The dispensing system 100 includes a processing element 120 in communication with one or more of: a conventional power supply and/or power source 130 (may include batteries, 110/220V source, voltage reducer, solar cell, surge protection, RF sources, and the like); a user output display 80 (the output “display” may include auditory; printed and/or visual output to a user, and the like); and user input device 118 (the user input device may include buttons, a keypad, voice/sound control, and/or motion detection, and the like).

The dispensing system 100 includes at least one container 112 having at least one state-sensitive element 54 in communication with processing element 120. A generic plurality of containers 112 (1 to n) is shown having parallel signal connections from each state-sensitive element 54 to processor 120, although other conventional communication and/or signal modalities may optionally be employed (separately or in combination), such as multiplexed signals, remote sensing and the like. The containers 112 are preferably disposable and matedly mounted in releasable docking receptacles (not shown in FIG. 11).

Typically, a plurality of containers 112 contain a variety of consumer products having different uses and characteristics. The state-sensitive elements 54 typically include devices for measuring the product quantity as a property most relevant to the particular product in the corresponding container 112, such as volume, weight, number of product units, container pressure, and the like, or combinations thereof. The state-sensitive elements 54 may optionally include devices or memories for reporting other container or product status features, such as product age, product spoilage, preservation-related environmental factors, and the like, or combinations thereof.

Processor 120 uses the some or all of the data received from state-sensitive elements 54 to determine one or more of: (a) a current product exhaustion and/or refill requirement for one or more of the containers 112; b) a predicted future time/date of product exhaustion and/or refill requirement for one or more of the containers 112; (c) a current product end-life and/or spoilage status for one or more of the containers 112; and (d) a predicted future product end-life and/or spoilage status for one or more of the containers 112.

The processor 120 may include a clock/calendar device and/or a memory device which records a history including some or all of the data received from state-sensitive elements 54 and/or some or all of the determinations (a) through (d) above. The processor may determine a user-specific consumption history of the at least one product and use the consumption history to predict a future product exhaustion and/or refill requirement.

The processor 120 may connect to (by wire or wireless device) and/or integrally include a conventional communication device 140 (may include dial-up modem, wireless transceiver or cable modem, and/or the like). Communication device 140 is configured to communicate with at least one corresponding communication device 180 of a corresponding online and/or E-commerce supplier business unit 190. The communication with supplier communication device 180 may include the use of any suitable conventional modality, such as via direct line dial-up connection 175; via internet 160 and ISP internet services providers 150a-170a (e.g., a SSL or other secured connection); via internet 160 and e-mail service providers 150b-170b, and the like, or combinations thereof.

Supplier communication device 180 is in communication with E-commerce supplier business unit 190, which may be organized in a conventional business structure. Typically business unit 190 has order-processing and financial transaction capability, and is in communication with at least one shipping and inventory unit 200 for purposes of filling and shipping orders to customers. It should be understood that many alternative generally equivalent business structures of the E-commerce supplier are possible, including various conventional commercial partnerships, agency relationships, order referrals, assignments, drop-shipping and the like.

Typically, the E-commerce supplier 190 will generally complete order transactions and shipping by use of commercial financial institutions and shipping services. Optionally, processor 120 may be configured to communicate electronically with financial institutions and shippers using the communication modalities such as described above to carry out a portion or all of the replacement container order process.

When processor 120 makes a determination that an order one or more replacement containers is needed, an electronic order is placed via communication as indicated above with a business unit 190. This may include user-programmed and/or pre-established relationships with e-commerce suppliers, including conventional pre-authorized financial payment previsions such as credit card accounts, deposit accounts, third party payment services, and the like. Processor 120 preferably includes memory elements to record the profile and transactional data for such user-programmed and/or pre-established relationships. Processor 120 may alert a user via output display 80 of the determined order requirement and/or determined invoice/transaction particulars. The user may then input order authorization (and optionally additional order data) via user input 118.

Alternatively, the processor 120 may be programmed to place an order entirely automatically by means of an auto-connected communication link to business unit 190. The automatic order protocol may be similar in many functional respects to those protocols used for automatic downloads of updates to software, such as operating systems and anti-virus software. Typically, a user will establish the bounds and criteria for automatic order placement via user inputs via input 118. The bounds and criteria for automatic order placement may be generally similar to those used in automated bill-paying systems, such as default or maxima criteria for money amounts, frequencies, duration and the like.

In another alternative, processor 120 may be connected to a user-operated personal computer 135 (by linkage such as a cable, wireless link, LAN, and/or the like), such that a user may input and receive data from the processor via the personal computer (not shown in FIG. 11). Optionally, the dispensing system 100 may include software and hardware for installation on the personal computer to perform one or more of the data processing and/or I/O functions described above on the personal computer, in communication with processor 120.

Following placement of an order, either automatically, or by user-authorization, business unit 190 instructs shipping unit 200 to ship one or more replacement containers to the user via conventional shipping modalities 300, such as UPS, Postal Service, Fed Express, and the like or combinations thereof.

Optionally, processor 120 may include an inventory management system 121 (including hardware and/or software elements) which is configured to manage orders for multiple replacement containers so as to either minimize cost to the user (such as for unit prices, shipping and handling charges, transaction fees, and the like) or maximize convenience (such as minimize delays, complexity, and/or wastage), or both. Optionally, the inventory management system may track and display order conformations and shipping status via automatic or user-directed communication with suppliers or shippers.

One of the challenges in configuring dispensing system 100 for automated and/or semi-automated communication with E-commerce suppliers, shippers, financial institutions and the like (e.g, supplier 190), is that such businesses may have a wide variety of different order placement and/or other transaction processes, typically via a sequence of web pages accessible through the Internet. For example, specified transactions information may be required by the E-commerce supplier to be entered by a customer in a particular format and sequence.

In one alternative, dispensing system 100 and/or processor 120 includes hardware and/or software elements providing for a “training” protocol whereby the user initially contacts and/or navigates the supplier website 190, for example by using input and outputs via devices 118 and 80, to complete a model container re-supply transaction, the processor including memory and logic elements to record a customized protocol specific to the supplier website, and/or to replicate a homologous container re-supply transaction with the supplier website at a future time, automatically and/or semi-automatically, based on the customized protocol. In a related alternative, the dispensing system 100 includes hardware and/or software elements providing for cooperative communication with personal computer 135, so that a user may “train” the dispensing system 100 and create customized protocols by completing model transactions via the computer user interface and processor.

Customized protocols for other related may be created by a user in a substantially similar manner to that described above. For example, a user may create a custom protocol for receiving order confirmation data from a supplier website; for receiving shipping tracking data shipper website; for receiving and/or transmitting payment data via a financial institution website; for compiling relevant data from automated email messages received from supplier and/or shippers; and the like, or combinations thereof.

Dispensing system 100 may include conventional hardware and/or software elements to provide for secure access to the Internet, including firewalls, IP address protection, and the like. The Internet access optionally may be conveniently limited to websites for which customized transaction protocols have been created by the user as described above, and/or limited to specific operations contained such customized transaction protocols.

FIGS. 1-6 show various perspective and detail views of embodiments of a personal or home dental care dispenser system, which may include various alternative aspects of the invention. For example, the container 42 shown in FIG. 5 may have additionally an embedded or “on board” IC chip (not shown) mounted in or on the container housing, so as to achieve a “smart can”. The IC chip may include memory and a microprocessor, a clock/calendar, and other accessory devices of known design, the chip being configured and connected so as to send and receive at least a signal to and/or from a computer and/or console-mounted processor via a communication means, such as electrical contacts 56. Power may be supplied via contacts from a console power supply, or alternatively container 42 may include a battery and/or other power source of known design. The IC chip may receive information directly from sensor 54.

The IC chip may be pre-programmed so as to monitor a use history of the container, among other things. For example, the chip may record the number of times the container is inserted and/or removed for the console, and/or may record the exhaustion of the contents and the number of time the cartridge is refilled. In one alternative, the container 42 may be configured as a single-use container, and the IC chip programmed to disable the cartridge after the contents are exhausted to prevent unauthorized refilling and/or reuse. Optionally, the chip may be made restorable, e.g. by a subsequently input proprietary code, so as to permit authorized quality-controlled refilling and/or reuse of container 42. The chip may include recycling data and/or history, e.g. to provide for compliance with regulatory requirements for spent product recycling and/or disposal, and/or to limit reuse to a safe container lifetime and/or cycle life.

A series of related and similarly configured embodiments of a personal dental care dispenser system may be made, according to aspects of the invention, providing a range of upgraded or specialized system configurations to suit marketing or user needs. For example:

a) a basic system having a mechanical and/or simple electrical controller/actuator and including a basic product container selection (e.g., toothpaste, floss, sanitizer);

b) an enhanced system having an electronic controller and/or all-electric actuator, and including a visual contents display and/or operating display, being supplied with battery power, and optionally additional container receptacles for further product offerings;

c) an enhanced system similar to (b), and having alternatively or additionally a connection for home power (e.g., 110V, 220V, or convertible power).

d) a further enhanced system similar to (b) and/or (c), and having an LCD display, and optional user programmable features via console processor (e.g., user programmable controls, to permit different products), and optionally having powered accessories, such as a dental irrigator, ultrasonic toothbrush or dental pick, and the like;

e) a still further enhanced system similar to (b), (c) and/or (d), further having wireless and/or wired connectivity to the internet via an on-board or external computer, to enable various described features, such as automated product ordering and inventory control.

The forgoing embodiments illustrate how various aspects of the invention provide synergistic functional enhancements by the inter-relation of the various products included in the systems. Such synergistic functional enhancement that might be advantageously provided by the product container include useful automated functional interaction with the system, additional automated information content, or enhancement of the function of other products supplied by the integrated system.

It should be understood that various modifications within the scope of this invention can be made by one of ordinary skill in the art without departing from the spirit thereof. It is therefore wished that this invention to be defined by the scope of the examined claims as broadly as the prior art will permit, and in view of the specification if need be. Accordingly, the scope of the present invention is limited solely by the appended claims.

1. An integrated dispensing console system comprising:
a base;
one or more docking receptacles for product containers; and
one or more containers configured to mate with a corresponding receptacle.

2. The system of claim 1, wherein the one or more of the containers is preferably disposable.

3. The system of claim 1, wherein the one or more of the containers are refillable refurbishable.

4. The system of claim 1, wherein the one or more of the containers preferably includes at least one state-sensitive element; and either or all of the containers and the corresponding state-sensitive element are disposable.

5. The system of claim 4, wherein the at least one state-sensitive element includes structures or devices configured:
(a) to detect, and/or measure, and/or to facilitate the detection and/or measurement of, one or more quantities or conditions related to properties of the container contents and/or the container;
(b) to store, receive, and/or transmit information related to one or more properties, history, and/or use of the container contents and/or the container;
(c) to modify, to condition and/or to regulate one or more properties of the container contents and/or the container;
(d) to provide an energy source and/or energy storage;
(e) to control, to energize and/or to activate the dispensing of container contents; or
(f) to carry out a combination of two of more of the foregoing.

6. The system of claim 4, wherein the at least one state-sensitive element includes structures or devices configured to perform a user-communication function that includes displaying a container contents fill-level, contents temperature and contents pressure.

7. The system of claim 1, further comprising a processing element in communication with an interface element disposed adjacent to the docking receptacle, wherein the interface element configured to engage and/or acquire a corresponding transfer element disposed on or in the one or more containers, in communication with the state-sensitive element.

8. The system of claim 7, wherein at least one signal is transmitted between the container state-sensitive element and the processing element when the one or more containers are mated with the docking receptacle.

9. The system of claim 8, wherein the interface element is configured to engage a transfer element so as to provide an electrical current path between the container and the console or permit wireless, optical, RF, magnetic, mechanical, acoustical and/or another signal transmission modality.

10. The system of claim 8, wherein the processing element is configured to use the one or more signals to at least to control a dispensing function of the console, a user-interface device disposed adjacent to the console, an output device disposed adjacent to the console or to regulate or change the temperature, pressure or energy charge-level of the contents of the container.

11. The system of claim 1, further comprising a security lock device arranged to prevent access by an un-authorized potential user from at least one of:
(a) dispensing the product contents of one or more of the containers; and
(b) disengaging one or more of the containers from its respective docking receptacle, while permitting an authorized user to do one or both of (a) and (b).

12. The system of claim 1, further comprising a treatment unit in communication with at least one of the containers via its respective docking receptacle so as to provide controlled movement of the contents of the container to the treatment unit; and wherein the treatment unit is configured to receive an implement to be treated, and to utilize the contents of the container to perform at least a part of treatment of the implement.

13. The system of claim 12, wherein the implement includes a tooth brush, and the treatment unit includes a toothbrush sanitizer, and a toothbrush hygienic storage station.

14. An integrated dispensing console system comprising:
a base;
at least two docking receptacles for product containers; and
at least two containers configured to mate with a corresponding receptacle, wherein the each of the at least two containers is configured to supply a product suitable for optimal use in conjunction and/or in sequence with the contents of the other of the at least two containers.

15. The system of claim 14, wherein:
a first one of the containers includes a first receptacle-specific mating portion configured to engage a first one of the docking receptacles;
a second one of the containers includes a second receptacle-specific mating portion configured to engage a second one of the docking receptacles; and
the first and second receptacle-specific mating portions are substantially distinct in conformation so that the first container is substantially prevented from docking in the second receptacle and the second container is substantially prevented from docking in the first receptacle, the contents of the first and second containers being different.

16. An integrated dispensing console system comprising:
a base;
a plurality of docking receptacles for product containers mounted to the base; and
a plurality of containers configured to mate with at least one of the receptacles, wherein the plurality of containers includes at least one detector configured to determine one or more product parameters selected from a fill-level, a product quantity, a charge-level and a useful life of the contents of at least one container.

17. The system of claim 16, wherein:
the plurality of containers include a plurality of substantially identical individually-releasable containers;
at least one of the plurality of receptacles including a magazine for housing the plurality of individually-releasable containers, and the magazine is arranged for release of at least one of individually-releasable containers upon user input, and
the detector produces a signal indicative of the remaining number of single-use containers housed in the magazine.

18. The system of claim 16, further including a processor unit in communication with the one or more detectors, the processor unit having an output configured to be connected with Internet, wherein the Internet connection output is connectable to one or more of the following: a wireless transceiver, a modem, a local area network connection device or combination thereof.

19. The system of claim 18, wherein the processor is configured to:
(a) communicate with one or more of the detectors of the containers so as to measure one or more product parameters;
(b) to determine whether a pre-selected product supply criteria correlated with a product re-order requirement is satisfied based on the one or more measured product parameters, so as to indicate a requirement for a product re-supply;
(c) if the product supply criteria is satisfied, to communicate with at least one product supplier via the Internet so as to place an order for re-supply of a pre-selected quantity of at least one product.

20. The system of claim 18, wherein:
at least on of the product containers includes a memory element and a communication element, the memory element configured to store a substantially unique container identification code and linked to the communication element so as to communicate a signal to the processor;
the processor is configured to communicate with the memory element of at least one container so as to read the substantially unique container identification code;
the processor is configured to measure at least one container parameter and to associate the container parameter with the substantially unique container identification code; and
the processor is configured to measure at least one container parameter and to associate the container parameter with the substantially unique container identification code; and
the processor is configured to communicate with at least one product supplier via the Internet so as to communicate the measured container parameter in association with the substantially unique container identification code to the product supplier.

21. A container configured for engagement and use with an integrated dispensing console system as is described in any of claims 1, 14 or 16, the container comprising a communication element configured to communicate at least a signal between the container and the dispensing console.

22. A container as in claim 19, further including an integrated circuit microprocessor (IC), wherein the IC is connected to the communication means; and wherein the IC includes at least memory programmed with information relating to one or more of: the contents of the container, a use history of the container, ownership rights, license rights, recycling data, disposal data, container-console compatibility, and product-console compatibility.

23. A container as in claim 22, further including at least one state-sensitive element.

24. A container as in claim 23, wherein the IC is configured to communicate with and receive data from the state sensitive element.

25. A container as in claim 20,
wherein the state sensitive element is configured to detect one or more of: the container contents amount and the container contents exhaustion;
wherein the IC is configured to record one or more of the container contents amount and the container contents exhaustion; and
wherein the IC is configured cause the container to be disabled for use in the console, so as to prevent refilling and reuse of the container upon IC determination of the occurrence of a pre-programmed event.

26. A container as in claim 24, wherein the pre-programmed event resulting in disablement includes one or more of the following events:
(a) the contents of the container have been exhausted;
(b) the container has been refilled more than a pre-selected number of times;
(c) a container shelf-life limit has been exceeded;
(d) an authorization criteria is not satisfied.

27. A container as in claim 24, wherein the IC is configured so as to permit the container to be re-enabled for use in the console following disablement, the IC be re-enabling the container upon receipt via the communication means of a predetermined code signal.

28. A container as in claim 24, wherein the communication element includes one or more of:
(a) an electrical contact;
(b) a wireless device; and
(c) a short range transceiver.

29. A container as in claim 21, further including a memory element linked to the communication element and configured to store a substantially unique container identification code; wherein the communication element is configured to transmit the substantially unique container identification code to a processor of the integrated dispensing console system.
